(19) United States
(12) Patent Application Publication
(10) Pub. No.: US 2011/0134367 A1
(43) Pub. Date: Jun. 9, 2011

(54) POLARIZATION SHEET AND LIQUID CRYSTAL DISPLAY DEVICE HAVING THE SAME

(76) Inventors: Se-Hong Park, Goyang (KR); Eung-Do Kim, Paju (KR); Jong-Sin Park, Seoul (KR)

(21) Appl. No.: 12/960,174

(22) Filed: Dec. 3, 2010

(30) Foreign Application Priority Data
Dec. 9, 2009 (KR) 10-2009-0121642

(51) Int. Cl. G02F 1/1335

(52) U.S. Cl. 349/64; 349/98

(57) ABSTRACT

Disclosed is a liquid crystal display device capable of enhancing luminance thereof, the device including a liquid crystal display panel for displaying an image; a light source for emitting light; a light guide plate for guiding the light emitted from the light source; an optical sheet above the light guide plate to enhance the efficiency of light input from the light guide plate; a polarization sheet above the optical sheet, the polarization sheet polarizing the light supplied to the liquid crystal display panel into a first polarizing direction and converting the light having a second polarizing component into the light having a first polarizing component to supply the light having the converted polarizing component into the liquid crystal display panel; and a polarizer onto the liquid crystal display panel to adjust transmittance of light transmitted through the liquid crystal display panel.

### RELATED APPLICATIONS

Pursuant to 35 U.S.C. §119(a), this application claims the benefit of earlier filing date and right of priority to Korean Application No. 10-2009-0121642 filed on Dec. 9, 2009, the contents of which is incorporated by reference herein in its entirety.

### BACKGROUND OF THE DISCLOSURE

1. Field of the Disclosure

The present disclosure relates to a polarization sheet and a liquid crystal display device having the same, and more particularly, a polarization sheet capable of polarizing light and simultaneously improving luminance and a liquid crystal display device having the same.

2. Background of the Disclosure

Recently, the development of various types of portable electric equipment, such as mobile phones, personal digital assistants (PDAs), and notebook computers, is increasing the demand for flat panel display devices, which are applicable to those equipment and small in size, light in weight and power-efficient. Examples of the flat panel display device are a liquid crystal display (LCD) device, a plasma display panel (PDP) device, a field emission display (FED) device, a vacuum fluorescent display (VFD) device and the like. Studies on those devices are actively conducted. Among others, the LCD device is currently in the limelight in view of its mass production technology, facilitation of driving scheme and implementation of high color rendering property.

The LCD device is a transparent display device, which realizes a desired image on a screen by adjusting light transmitting through a liquid crystal (LC) layer by virtue of refractive index anisotropy of liquid crystal molecules. Accordingly, the LCD device is provided with a backlight unit as a light source for generating light, which transmits through the LC layer for realizing an image. In general, there may be two types of backlight units.

A first type of backlight unit is an edge type backlight unit which is installed at a side surface of a liquid crystal (LC) panel for emitting light toward the LC layer, and a second type of backlight unit is a direct type backlight unit, which emits light directly below the LC panel.

The edge type backlight unit may be installed at the side surface of the LC panel to supply light to the LC layer via a reflector and a light guide plate, so as to be made thin in thickness, whereby it is usually used in a laptop computer or the like requiring a thin display device.

The direct type backlight unit may be configured such that light emitted from a lamp is supplied directly to the LC layer, to be applicable to a large LC panel. Also, this type backlight unit can provide high luminance, so, recently, it is usually used for fabrication of an LC panel for LCD TV.

FIG. 1 is a view showing a structure of an LCD device having an edge type backlight unit.

As shown in FIG. 1, the LCD device 1 includes an LC panel 40, and a backlight unit 10 installed at a rear surface of the LC panel 40 for supplying light to the LC panel 40. The LC panel 40 is for actually displaying an image thereon, and includes first and second substrates 50 and 45, such as glass, and a liquid crystal (LC) layer (not shown) interposing between the first and second substrates 50 and 45. In particular, although not shown, the first substrate 50 is a thin film transistor (TFT) substrate for forming switching devices such as TFTs and pixel electrodes, and the second substrate 45 is a color filter substrate for forming a color filter layer thereon. Also, a driving circuit unit 5 is disposed at each side surface of the first substrate 50 so as to apply a signal to each of the TFTs and the pixel electrodes formed on the first substrate 50.

The backlight unit 10 includes lamps 11 for actually emitting light, a light guide plate 13 for guiding light emitted from the lamps 11 toward the LCD panel 40, a reflector 17 for reflecting light emitted from the lamps 11 toward the light guide plate 13 to improve optical efficiency, and an optical sheet having a diffusion sheet 15 and a prism sheet 20 disposed above the light guide plate 13.

With the configuration of the backlight unit 10, light emitted from the lamps 11 installed at both side surfaces of the light guide plate 13 is incident onto the light guide plate 13 via the side surfaces of the light guide plate 13, and the incident light is then incident onto the LC panel 40 in a state where the optical efficiency of the light is improved by an optical sheet disposed above the light guide plate 13.

Light transmitted through the light guide plate 13 is incident onto the diffusion sheet 15 and the prism sheet 20. Such light is diffused by the diffusion sheet and turned toward the front surface of the LC panel 40 by the prism sheet 20 to be output.

A polarizer 5a and 5b is disposed at each of upper and lower surfaces of the LC panel 40. Light emitted from the backlight unit 10 is polarized by the first polarizer 5a attached onto the first substrate 50 and such polarized state is converted after being transmitted through the LC layer, thereby being output externally via the second polarizer 5b attached onto the second substrate 45. Here, the transmittance of the light transmitted through the second polarizer 5b is adjusted according to the change in the light polarized state by the LC layer, thereby realizing an image.

However, the LCD device with the above construction may have the following problem. Since the LCD device as a transparent display device provides lower optical efficiency than typical display devices, so its luminance is also low. For instance, in the LCD device, the LC panel 40 absorbs most of light emitted from the backlight unit 10, and light transmitted through the LC panel 40 merely corresponds to about 5% of entire light emitted from the backlight unit 10, which indicates that the LCD device has luminance lower than the typical display devices.

### SUMMARY

A polarization sheet includes, a first base film and a second base film; and a polarizing unit between the first base film and the second base film, the incident light being polarized in the first polarization direction by the polarizing unit to output and the light having a second polarization component is converted into the light having a first polarization component to output by the polarizing unit

In accordance with one embodiment of the present invention, there is provided a liquid crystal display device including a liquid crystal display panel for displaying an image; a light source for emitting light; a light guide plate for guiding the light emitted from the light source; an optical sheet above the light guide plate to enhance the efficiency of light input from the light guide plate; a polarization sheet above the optical sheet, the polarization sheet polarizing the light supplied to the liquid crystal display panel into a first polarizing direction and converting the light having a second polarizing component into the light having a first polarizing component to supply the light having the converted polarizing component into the liquid crystal display panel; and a polarizer onto the liquid crystal display panel to adjust transmittance of light transmitted through the liquid crystal display panel.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a view showing a structure of an LCD device according to the related art;

FIG. 2 is a disassembled perspective view showing a structure of an LCD device in accordance with the present invention;

FIG. 3 is a sectional view showing a structure of an LC panel of the LCD device in accordance with the present invention;

FIG. 4 is a view showing the structure of the LC panel of the LCD device in accordance with the present invention;

FIG. 5 is a sectional view showing a structure of a polarization sheet of the LCD device in accordance with the present invention; and

FIG. 6 is a sectional view showing a structure of another polarization sheet of the LCD device in accordance with the present invention.

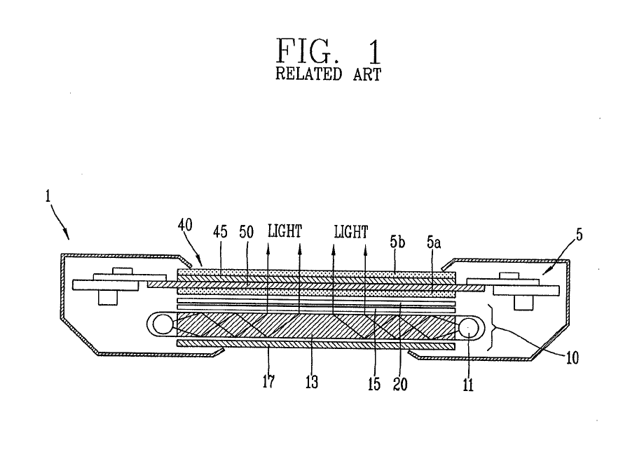

### DETAILED DESCRIPTION OF THE EXEMPLARY EMBODIMENTS

Hereinafter, description will be given of a backlight unit and an LCD device having the same in accordance with the present invention with reference to the accompanying drawings.

The best way to improve luminance of an LCD device is to increase an amount of light incident onto an LC panel. Although light input to the LC panel is merely 5% of entire light emitted from a backlight, if an amount of input light increases, an amount of light supplied to the LC panel increases as well (most light is absorbed by the LC panel, but an amount of light transmitted through the LC panel also increases at the same rate as the amount of light increases in the backlight), the luminance of the LCD device could be improved.

As such, in order to increase a quantity of light supplied to the LC panel, the number of light sources for emitting light should increase or power applied to the light source should increase to enhance luminance of the light source. However, the increase in the number of light sources causes an increase in a fabrication cost, and the increase in the power applied to the light source increases power consumption, thereby making the LCD device larger in size. Also, even in these cases, most light (about 95% of light) supplied to the LC panel is absorbed by the LC panel, so there still remains a limitation to improve the luminance by way of the increase in the number of light sources or power.

The present invention may improve the luminance of the LCD device by removing a polarizer attached onto the LC panel. Typically, when light emitted from the backlight unit is incident onto the LC panel, about 40% of the incident light is absorbed by a polarizer, 0.7% of the light is absorbed by a glass substrate, and about 30% of the light is absorbed by a color filter layer. In other words, the polarizer, among components of the LCD device, is the main factor of deterioration of the light luminance. So, the present invention removes the polarizer, as the biggest cause of the luminance deterioration, so as to improve luminance of the LCD device. When improving the luminance by increase in the number of light sources or power, the light absorption factor at the LC panel is left, so there still remains a limitation to enhance luminance. However, in the present invention, the primary cause of the luminance deterioration is removed, so the luminance can be remarkably enhanced.

Especially, in the present invention, since incident light is polarized and simultaneously incident light is reflected without being absorbed by the LC panel to be then incident again, the polarized light can be supplied to the LC panel even without a polarizer and also the luminance of the LCD device can be maximized.

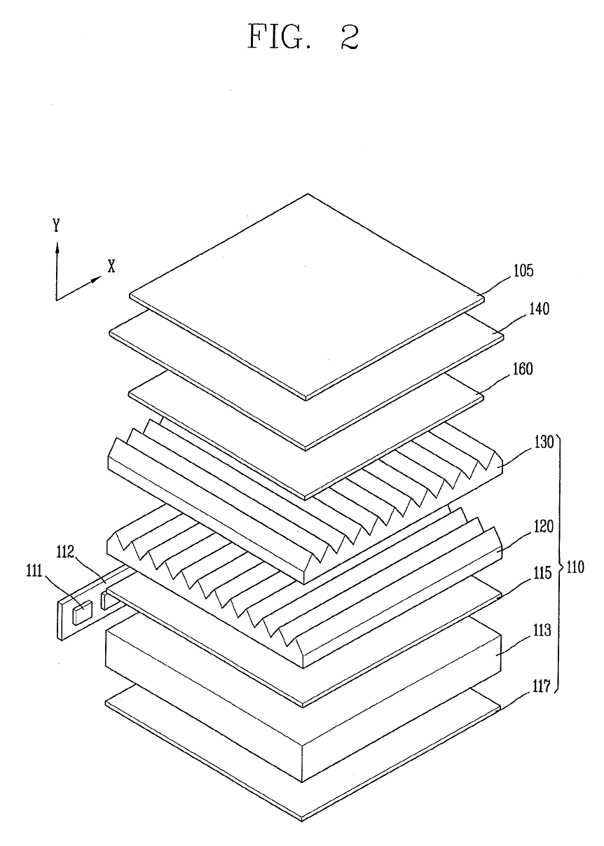

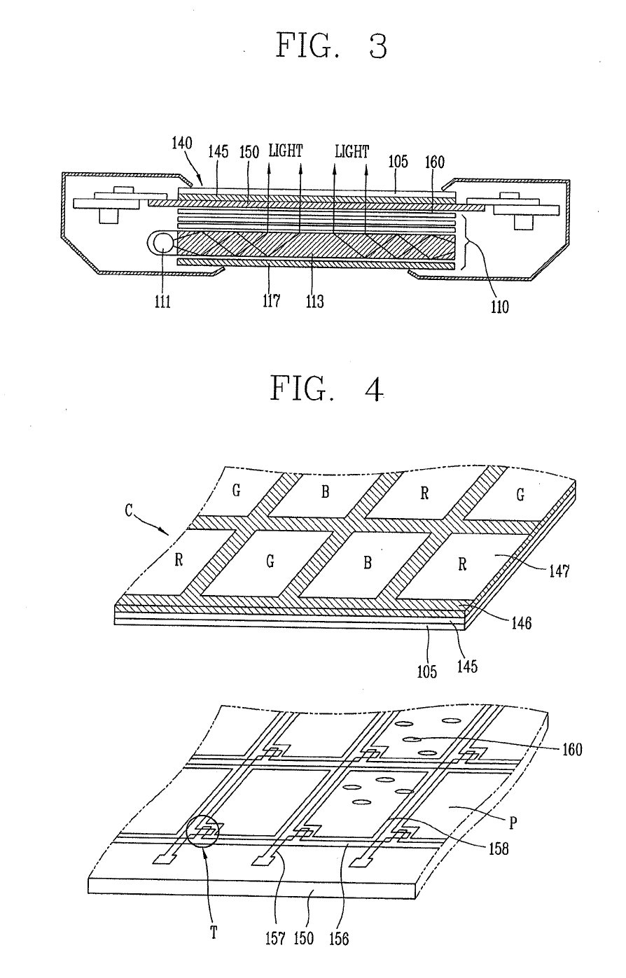

FIG. 2 is a disassembled perspective view showing a structure of an LCD device in accordance with the present invention, and FIG. 3 is a sectional view of the LCD device in accordance with the present invention.

As shown in FIGS. 2 and 3, an LCD device 100 may include an LC panel 140 and a backlight unit 110. Here, the backlight unit 110 may be located below the LC panel 140 to supply light to the LC panel 140.

The backlight unit 110 may include a light source 111 for emitting light toward the LC panel 140, a light guide plate 113 located below the LC panel such that a side surface thereof comes in contact with the light source 111 and configured to supply light incident from the light source 111 via the side surface thereof toward the LC panel 140, a reflector 117 disposed below the light guide plate 113 for reflecting light incident onto a lower side of the light guide plate 113 toward the LC panel 140, a diffusion sheet 115 disposed between the LC panel 140 and the light guide plate 113 for diffusing light guided by the light guide plate 113, a first prism sheet present between the diffusion sheet 115 and the LC panel 140 and having a plurality of prisms aligned in one direction so as to refract light diffused by the diffusion sheet 115 toward a front surface of the LC panel 140, a second prism sheet 130 disposed on the first prism sheet 120 and having prisms aligned in another direction from the prisms of the first prism sheet 120 so as to re-refract the light refracted by the first prism sheet 120, and a polarization sheet 160 formed above the second prism sheet 130 for polarizing light supplied to the LC panel 140 so as to supply the polarized light to the LC panel 140.

Also, a polarizer 105 is attached on an upper surface of the LC panel 140. However, a polarizer is not attached onto a lower surface of the LC panel 140, unlike the related art. In the present invention, the polarization sheet 160 may serve as the related art polarizer attached on the lower surface of the LC panel 140.

After light emitted from the backlight unit 110 is diffused and converged by the diffusion sheet 115 and the prism sheets 120 and 130 via the light guide plate 113, such light is input into the polarization sheet 160. The input light is polarized by the polarization sheet 160 to be supplied to the LC panel 140. Here, with the configuration of the polarization sheet 160, light polarized to one axial component is transmitted and a polarized state of light of another axial component is reflected to be varied back into the one axial component so as to be transmitted, accordingly, most of light can be supplied to the LC panel 140 in the polarized state without being absorbed by the LC panel 140.

Light incident onto the LC panel 140 changes its polarized state while transmitting through the LC layer, thereby being externally output via the polarizer 105. Here, the transmittance of light transmitted through the polarizer 105 may be adjusted according to alignment of liquid crystal molecules of the LC layer, so as to realize an image on the LCD device.

Referring to FIG. 4, the LC panel 140 may include a first substrate 150, a second substrate 145 and an LC layer (not shown) between the two substrates 150 and 145. The first substrate 150 may include a plurality of gate lines 156 and data lines 157 arranged in a matrix configuration so as to define a plurality of pixel regions P, and each pixel region P is provided with a thin film transistor (TFT) T and a pixel electrode 158 electrically connected to the TFT T. A gate pad and a data pad are formed at end portions of the gate line 156 and the data line 157, respectively, so as to connect the gate line 156 and the data line 157 to external driving devices, thereby allowing an input of an external signal via the gate line 156 and the data line 157.

Although not shown, the TFT T may include a gate electrode connected to the gate line 156 for allowing an input of an external scan signal via the gate line 156, a gate insulating layer formed on the gate electrode, a semiconductor layer formed on the gate insulating layer and activated responsive to an input of a scan signal to the gate electrode so as to form a channel, and source and drain electrodes formed on the semiconductor layer for applying an image signal input via the data line 157 to the pixel electrode 158 as the channel is formed on the semiconductor layer responsive to the scan signal.

The second substrate 145 may include a black matrix 146 formed on an image non-display region, on which an image is not actually realized, such as the formation regions for the gate lines 156, data lines 157 or the TFTs, so as to prevent degradation of image quality due to light transmission through the image non-display region, and a color filter layer 147 formed within a pixel region and having red (R), green (G) and blue (B) sub color filter layers for rendering an actual image.

An LC layer (not shown in a drawing) is present between the first and second substrates 150 and 145 having the aforesaid structure, thereby implementing the LC panel 140.

The light source 111 may be implemented with a light emitting diode (LED). Here, an LED substrate 112 is disposed at a side surface of the light guide plate 113 and a plurality of LEDs are mounted in the LED substrate 112. The LED, as a light source which emits light by itself, emits R, G and B monochromatic light, so it can be advantageous in providing high color rendering characteristic and reducing driving power upon being applied to the backlight unit.

Upon employment of the LED as the light source 111 of the backlight unit, when light emitted from the LED is supplied to the LC panel, white light is supplied thereto other than monochromatic light being directly supplied thereto. For making white light by using the monochromatic light emitted from the LED, an LED emitting monochromatic light and phosphors may be used, an LED under infrared waveband and the phosphors may be used, or each monochromatic light emitted from R, G and B LEDs may be mixed. That is, upon use of the LED as the light source 111 of the backlight unit, a plurality of LEDs are located at a side surface of the light guide plate 113 so as to input white light or monochromatic light into the light guide plate 113.

In the meantime, the light source may be implemented by use of a fluorescent lamp, such as a cold cathode fluorescent lamp (CCFL). In this case, a housing for accommodating the lamp is provided at the side surface of the light guide plate 113 such that light emitted from the lamp can be reflected at the surface of the housing to be incident onto the light guide plate 113.

Also, the light source 111 may be formed either at one side of the light guide plate 113 or at both sides of the light guide plate 113, such that light emitted from the light source 111 can be incident onto the light guide plate 113 via both side surfaces of the light guide plate 113.

Alternatively, the light source 111 may be disposed below the light guide plate 113 other than at the side surface thereof. In this structure, light can be supplied from the light source directly to the LC panel 140, so the light guide plate 113 may not be used.

The light guide plate 113 may be formed of polymethyl-methacrylate (PMMA). When light incident on one side surface or both side surfaces of the light guide plate 113 is then incident on an upper or lower surface inside the light guide plate 113 at an angle smaller than a threshold angle, such light is totally reflected to proceed from one side of the light guide plate 113 to another side thereof. On the other hand, when light is incident on the upper or lower surface inside the light guide plate 113 at an angle larger than a threshold angle, such light is output externally to be reflected by the reflector 117 or incident onto the optical sheet 126.

The diffusion sheet 115 may diffuse light output from the light guide plate 113 to obtain uniform luminance, and be usually fabricated by distributing a spherical seed made of acryl-based resin on a base film made of polyester (PET). Light transmitted through the light guide plate 113 is diffused by the spherical seed so as to become uniform in luminance. The drawing shows the diffusion sheet 115 present between the light guide plate 113 and the first prism sheet 120; however, another diffusion sheet may further be provided between the second prism sheet 130 and the LC panel 140.

The prism sheets 120 and 130 may be configured by forming uniform prisms made of acryl-based resin on a base film made of polyester (PET) so as to refract incident light to be turned toward a front side. Here, the prisms of the first and second prism sheet 120 and 130 may be aligned perpendicular to each other to refract incident light toward a front surface, thereby enhancing the front surface luminance of the light. Here, as shown in the drawing, the prisms of the first and second prism sheets 120 and 130 are aligned in different directions, namely, perpendicularly in a x-axial direction and a y-axial direction, so the light is refracted in the x-axial direction and the y-axial direction so as to be perpendicularly incident onto the LC panel 140.

The polarization sheet 160 may polarize incident light converged by the second prism sheet 130 to supply to the LC panel 140. That is, the polarization sheet 160 may perform the same function as a typical polarizer. However, the typical polarizer used in the related art merely transmits light polarized to one axis and absorbs light polarized to another axis, thus providing extremely low transmittance of the polarizer. However, the polarization sheet 160 according to the present invention polarizes most of light to supply to the LC panel 140, so there is no absorption of light by the polarization sheet 160, thereby non-occurrence of degradation of luminance. In other words, since light absorption by the lower polarizer of the related art LCD device does not occur in the present invention, the present invention can achieve an effect of luminance enhancement as much as the degradation of luminance due to the lower polarizer.

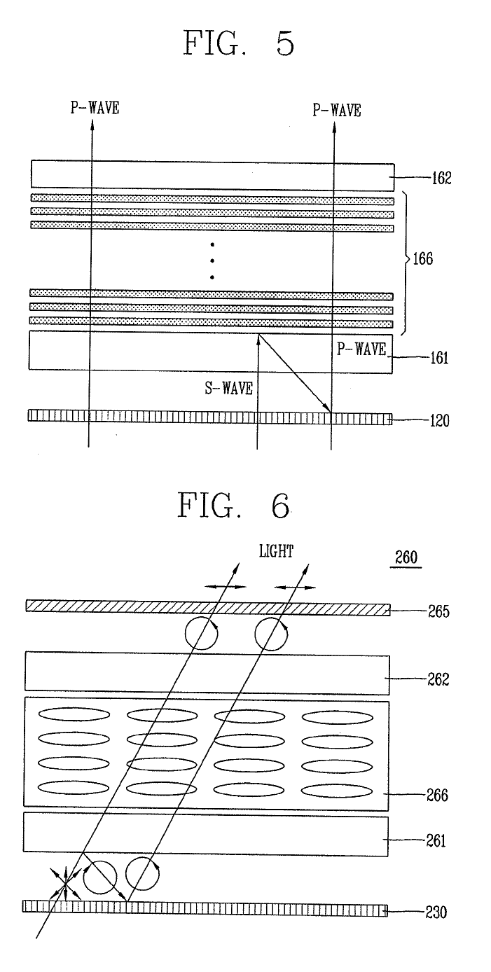

FIG. 5 is a view showing a configuration of the polarization sheet 160 according to the present invention. As shown in FIG. 5, the polarization sheet 160 according to the present invention may include a first base film 161, a second base film 162, and a polarizing unit 166 disposed between the first and second base films 161 and 162 and made of several hundred sheets of isotropic media and anisotropic media with a high double refraction characteristic so as to transmit P-wave components and reflect S-wave components of incident light.

The first and second base films 161 and 162 are transparent films, which may be made of polyester (PET), polymethyl-methacrylate (PMMA), poly carbonate (PC) or the like.

Referring to FIG. 5, when light is input from the backlight unit 110 to the polarization sheet 160, among the input light, P-wave is transmitted through the polarizing unit 166 but S-wave is reflected without being transmitted through the polarizing unit 166. The reflected S-wave is re-reflected by the optical sheet (i.e., the prism sheets 120 and 130 and the diffusion sheet 115) and the reflector 117 disposed below the polarization sheet 160, to thereby be incident onto the polarization sheet 160. Here, the polarized state of the light is converted from S-wave into P-wave by the reflection. The polarization sheet 160 thus transmits P-wave, so the P-wave reflected by the optical sheet and the reflector 117 is transmitted through the polarization sheet 160, whereby entire light emitted from the light source 111 can be supplied to the LC panel 140 in the polarized state to the P-wave.

As such, in the present invention, the polarization sheet 160 converts S-wave into P-wave to output P-wave, thereby supplying the polarized light to the LC panel 140. Consequently, the polarization sheet 160 according to the present invention can not only function as the related art polarizer but also supply the entire light emitted from the backlight unit 110 to the LC panel 140, thereby minimizing degradation of luminance.

FIG. 6 is a view showing a configuration of another polarization sheet 260 in accordance with the present invention.

As shown in FIG. 6, a polarization sheet 260 may include a first base film 261, a second base film 262, a polarizing unit 266 present between the first and second base films 261 and 262 and formed of cholesteric liquid crystal so as to transmit light of right-handed circular polarized component and reflect light of left-handed circular polarized component, and λ/4 retardation film 265 attached onto the second base film 262 for performing a retardation conversion for circularly polarized light transmitted through the polarizing unit 266 so as to supply linearly polarized light to the LC panel 140.

The polarizing unit 266 is formed of the cholesteric liquid crystal with a periodical spiral structure, so it may transmit circularly polarized light of the same direction as the spiral structure and reflect circularly polarized light of another direction. The λ/4 retardation film 265 is implemented as a transparent film such as poly carbonate (PC).

The foregoing description is given of a structure in which the right-handed circular polarized light is transmitted through the polarizing unit 266 and left-handed circular polarized light is reflected by the polarizing unit 266. Alternatively, the left-handed circular polarized light may be transmitted through the polarizing unit 266 and the right-handed circular polarized light may be reflected by the polarizing unit 266 according to the direction of the spiral structure of the cholesteric liquid crystal of the polarizing unit 266.

As shown in FIG. 6, when light is incident from the backlight unit onto the polarizing unit 266 of the polarization sheet 260, the left-handed circular polarized light proceeds to be transmitted through the polarizing unit 266, whereas the right-handed circular polarized light is reflected without being incident onto the polarizing unit 266.

The left-handed circular polarized light transmitted through the polarizing unit 266 is converted into the linearly polarized light while being transmitted through the λ/4 retardation film 265.

In addition,, the right-handed circular polarized light reflected by the polarizing unit 266 is reflected by an optical sheet 230 and/or a reflector, to be incident again onto the polarization sheet 260. Here, the light reflected by the optical sheet 230 and/or the reflector is converted from the right-handed circular polarized light into the left-handed circular polarized light. Since the polarization sheet 260 allows the left-handed circular polarized light to be transmitted therethrough, the reflected light whose polarized state is converted into the left-handed circular polarized light is incident back onto the polarization sheet 260 and transmitted therethrough. Such light is then transmitted through the 214 retardation film 265 to be converted into the linearly polarized light, thereby being supplied to the LC panel.

As described above, the polarization sheet 260 even in this structure may polarize light emitted from the backlight unit to supply to the LC plane. In other words, the polarization sheet 260 according to the present invention may perform the same function as the polarizer of the related art LCD device. Also, the polarization sheet 260 according to the present invention reflects therein both light polarized to a specific direction and light polarized to another direction to convert their polarization directions for transmission. Hence, light emitted from the backlight unit can all be incident onto the LC panel without being absorbed by the polarization sheet 260, resulting in remarkable enhancement of luminance as compared with the related LCD device using the polarizer.

As described above, in the LCD device according to the present invention, the polarization sheet can function as the related art polarizer for polarizing light incident onto an LC layer and also improve luminance of incident light. Therefore, the luminance of the LCD device employing the polarization sheet according to the present invention can be remarkably enhanced as compared with the related art LCD device.

According to the present invention, as compared to an LCD device using the typical polarizer for polarizing light incident onto the LC layer, the luminance of the LCD device having the polarization sheet according to the present invention has been improved by about 40%.

Meanwhile, the foregoing description has been given of the specific structures of the LC panel and the backlight unit, however, it is merely illustrative and will not be construed to limit the present invention. If a polarizer below the LC layer used in the related art is removed and the polarization sheet is disposed at the backlight unit in the present invention so as to polarize light supplied to the LC panel and simultaneously enhance luminance, any structures of LC panel and backlight unit can be applied to the present invention. In other words, other embodiments or variations of the LCD device using the basic concept of the present invention may easily be derived by a person skilled in the art.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A polarization sheet comprising:
a first base film and a second base film; and
a polarizing unit between the first base film and the second base film, the incident light being polarized in a first polarization direction by the polarizing unit to output and the light having a second polarization component converted into the light having a first polarization component to output by the polarizing unit.

2. The polarization sheet of claim 1, wherein the polarizing unit comprises several hundred sheets of isotropic media and anisotropic media with a high double refraction characteristic, so as to transmit P-wave components and reflect S-wave components of the incident light.

3. The polarization sheet of claim 1, wherein the polarizing unit comprises cholesteric liquid crystal so as to transmit the circularly polarized light in a first direction and reflect the circularly polarized light in a second direction opposite to the first direction.

4. The polarization sheet of claim 3, further comprising a retardation film for converting the circularly polarized light in the first direction, transmitted through the polarizing unit, into linearly polarized light.

5. A liquid crystal display device comprising:
a liquid crystal display panel that displays an image;
a light source that emits light;
a light guide plate that guides the light emitted from the light source;
an optical sheet above the light guide plate to enhance the efficiency of light input from the light guide plate;
a polarization sheet above the optical sheet, the polarization sheet polarizing the light supplied to the liquid crystal display panel into a first polarizing direction and converting the light having a second polarizing component into the light having a first polarizing component to supply the light having the converted polarizing component into the liquid crystal display panel; and
a polarizer on the liquid crystal display panel to adjust transmittance of light transmitted through the liquid crystal display panel.

6. The device of claim 5, wherein the polarization sheet comprises:
a first base film and a second base film; and
a polarizing unit between the first base film and the second base film, the incident light being polarized in a first polarization direction by the polarizing unit to output and the light having a second polarization component converted into the light having a first polarization component to output by the polarizing unit.

7. The device of claim 6, wherein the polarizing unit comprises several hundred sheets of isotropic media and anisotropic media with a high double refraction characteristic, so as to transmit P-wave components and reflect S-wave components of the incident light.

8. The device of claim 6, wherein the polarizing unit comprises cholesteric liquid crystal so as to transmit the circularly polarized light in a first direction and reflect the circularly polarized light in a second direction opposite to the first direction.

9. The device of claim 8, wherein the polarization sheet further comprises a retardation film for converting the circularly polarized light in the first direction, transmitted through the polarizing unit, into linearly polarized light.

10. The device of claim 5, wherein the polarization sheet transmits the first polarized light and reflects the second polarized light, the reflected second polarized light being reflected by the optical sheet to be converted into the first polarized light, thereby being transmitted through the polarization sheet.

11. The device of claim 5, further comprising a reflector below the light guide plate to reflect light output from the light guide plate back to the light guide plate, the reflector reflecting the second polarized light reflected at the polarization sheet to polarize to the first polarized light so as to supply to the polarization sheet.
